(19) United States
(12) Patent Application Publication
(10) Pub. No.: US 2026/0261587 A1
(43) Pub. Date: Sep. 3, 2026

(54) INTERNET PROTOCOL MULTIMEDIA SUBSYSTEM NODE, USER EQUIPMENT AND METHODS IN A COMMUNICATIONS NETWORK

(71) Applicant: Telefonaktiebolaget LM Ericsson(publ), Stockholm (SE)

(72) Inventors: Charles Hegarty, Stockholm (SE); Afshin Abtin, Sollentuna (SE); Hakan Österlund, Ekerö (SE); Sorin Surdila, Laval,Québec (CA); Mattias Dahlqvist, Stockholm (SE)

(21) Appl. No.: 19/489,468

(22) PCT Filed: Jun. 9, 2023
(86) PCT No.: PCT/EP2023/065452

§ 371 Date: Dec. 2, 2025

(51) Int. Cl. H04L 65/1069; H04L 65/1016; H04L 65/1073

(52) U.S. Cl. CPC H04L 65/1069; H04L 65/1073; H04L 65/1016

(57) ABSTRACT

The method is for handling an Augmented Reality (AR) Service for a User Equipment (UE) in a communications network. The network node obtains a first indication indicating that the UE is AR capable. The network node sends a second indication to the UE. The second indication indicates that AR capability is supported in a conversation AR network. Based on the sent second indication, the network node receives a request for an AR session from the UE. The request comprises a third indication indicating an AR service requested for the AR session. The network node sends the request comprising the third indication towards a remote side of the AS session. The network node selects a media function for the AR session based on the third indication and a response to the request from the remote side and sets up the AR session between the UE and a remote end.

### TECHNICAL FIELD

Embodiments herein relate to an Internet Protocol Multimedia Subsystem (IMS) network node, a User Equipment (UE), and a methods therein. In some aspects, they relate to handling an Augmented Reality (AR) service in an IMS network for a UE in a communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5G Core (5GC) is core network, NR is radio access network. As a continued network evolution, the new release of 3GPP specifies a 5G network also referred to as 5G New Radio (NR) and 5GC.

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

In the last few years, AR has been an area of intense research covering numerous topics such as e.g., glasses, device configurations, RAN, Packet Core and AR Service Network capabilities, and AR codecs. As result 3GPP also started to work on AR requirements in 3GPP Release 16 and 17, see 3GPP Release 17, TR 26.998 Support of 5G Glass-type Augmented Reality/Mixed Reality (AR/MR) devices. Further there has been an increased focus on AR solution specification in 3GPP ongoing Release 18, specifically related to conversational AR architecture and technologies. The 3GPP work is expected to continue in Release 19 and beyond.

Although some early market solutions may be seen today, industry analysts expect to see increased AR market adoption starting with 2025, and to become a more mainstream technology starting with 2028.

Among the different AR use cases, one of the most challenging is conversation AR in which any of the two or more parties involved into a conversation such as e.g., a conference, may generate and consume AR content with an expected Quality of Experience (QoE).

3GPP Release 18 works on specifying three possible architectures for conversational AR:

1. An IMS based architecture which uses and when needed, extends the IMS and Data channel capabilities.

2. An architecture applicable for Over-The-Top (OTT)s, e.g., Facebook and Microsoft, in which the AR system is handled by an OTT which only uses RAN and packet core Communication Service Provider (CSP) infrastructure and may use some AR enablers in the CSP network.

3. A new Web Real-Time Communication (WebRTC) based AR system architecture, intended for CSPs and designed from scratch to be optimized for conversational AR, and eliminate the need for backward compliance towards legacy networks.

Existing WebRTC (Web Real-Time Communication) is a free and open-source project providing web browsers and mobile applications with Real-Time Communication (RTC) via Application Programming Interfaces (APIs). It allows audio and video communication to work inside web pages by allowing direct peer-to-peer communication, eliminating the need to install plugins or download native applications.

A simplified model covering both Model 1 and Model 3 is depicted in FIG. 1. FIG. 1 illustrates a generic representation of 3GPP Conversational AR Models 1 and 3, wherein App means application, AR-SS means augmented reality—signaling server, and NNI means network-to-network interface.

Both these models are targeted for CSPs, which intend to provide the AR System capabilities for AR applications running on mobile and fixed devices. Such AR system capabilities include but are not limited to AR user Authentication and/or Authorization, Addressing, Find and Connect AR.

### SUMMARY

As part of developing embodiments herein, the inventors identified some problems that first will be described.

There is a lack of capability negotiation mechanism's enabling network function, e.g., as deployed in Model 1 or Model 3, to determine that the service request, e.g., from the UE, is for an AR service on an AR enabled device. Furthermore, there are no capability negotiation mechanisms available to enable AR capable devices to determine what the network, e.g. as represented in Model 1 or model 3, supports.

As described in FIG. 1, the AR application 10 running on the device and the network relies on the standardized capabilities of the AR System 14, so that the AR application can focus on the application logic only. In Model 1 the Conversation AR system is based on IMS and IMS Data Channel, while in Model 3 it is represented by a new WebRTC based AR system. The Model 3 Conversational System is expected to implement similar functionalities to those supported by IMS, however they will be more AR optimized and without the burden of backward compatibility.

Moreover, the UE must indicate to the IMS and/or WebRTC based system, the AR capabilities it supports and is requesting.

For completeness, with 3GPP Model 2 (not shown), the CSP will provide the NR and 5GC Capabilities, while the AR system and the AR applications will be provided by the OTT.

The IMS architecture is specified by 3GPP and is detailed in 3GPP TS 23.228 and TS 24.229. 5GC architecture and procedures are specified in 3GPP TS 23.501 and 23.502, and EPC architecture and procedures are specified in 3GPP TS 23.401.

3GPP Release 16 and 17 analysed AR use cases where several are conversational AR, meaning that they imply that two or more parties are involved in the AR session.

3GPP Release 18 in Service and system Aspects (SA) group 2 and 4 (SA2) and (SA4) are specifying realization of conversational AR use cases where one of the options are based on IMS.

When conversational AR is introduced in 3GPP for example model 1 (IMS based), IMS will be the service engine whereby a single IMS core will serve AR users. From an IMS perspective, the AR enabled device, e.g. a UE, and service displays characteristics of a traditional VoNR and/or 5GC service enabled device that e.g. will roam and/or move etc. However, depending on the characteristics of the AR device and AR service application and/or service it may not roam or move access and may require specific handling from the network, e.g., offload requiring a network provided media server, etc. There is no framework or mechanism available to aid Model 1 and Model 3 WebRTC based functions in determining that the request to be served is for an AR service on an AR enabled device. Furthermore, there is no mechanisms available to enable the AR capable device, e.g., a UE, to determine what the network supports.

Certain functions in IMS and Model 3 need to differentiate when it comes to specific service offerings and what is supported by the UE. An example of some of these functions:
Multi-Media Telephony (MMTel) Application Server (AS) services like communication barring (roaming) may not need to be invoked, Certain location-based services also need to be service & device aware.
Service Centralization and Continuity Application Server (SCC AS) may not need to be invoked, e.g., Terminating Access Domain Selection (T-ADS) etc., for AR service specific devices while the AR service is not applicable for to 2G and/or 3G, the device may still be able to move and/or attach to 2G/3G due to limited-service availability.
In its handling of emergency calls, a Location Retrieval Function (LRF) needs to differentiate between service specific devices, it needs to determine that an emergency service for conversational AR, if subject to regulation, is unique and is not Voice over NR (VoNR) on a traditional “mobile” device.
Media server selection if rendering and/or offload is required.

An object of embodiments herein is to improve the handling of an AR service for a UE in a communications network.

According to an aspect of embodiments herein, the object is achieved by a method performed by a network node. The method is for handling an Augmented Reality, AR, Service for a User Equipment, UE, in a communications network. The network node obtains a first indication indicating that the UE is AR capable. The network node sends a second indication to the UE. The second indication indicates that AR capability is supported in a conversation AR network. Based on the sent second indication, the network node receives a request for an AR session from the UE. The request comprises a third indication indicating an AR service requested for the AR session. The network node sends the request comprising the third indication towards a remote side of the AS session. The network node selects a media function for the AR session based on the third indication and a response to the request from the remote side and sets up the AR session between the UE and a remote end using the selected media function for the AR session.

According to an aspect of embodiments herein, the object is achieved by a method performed by a User Equipment, UE. The method is for handling an Augmented Reality, AR, Service in a communications network. The UE receives a second indication from a network node. The second indication indicates that AR capability is supported in a conversation AR network. Based on the second indication, the UE sends a request for an AR session to the network node. The request comprises a third indication indicating an AR service requested for the AR session. The request comprising the third indication is to be forwarded towards a remote side of the AS session. The UE obtains from the network node, a setup of the AR session using a media function for the AR session. The media function is selected based on the third indication.

According to another aspect of embodiments herein, the object is achieved by a network node configured to handle an Augmented Reality, AR, Service for a User Equipment, UE, in a communications network. The network node is further configured to:
obtain a first indication indicating that the UE is AR capable,
send to the UE, a second indication indicating that AR capability is supported in a conversation AR network,
based on the sent second indication, receive a request for an AR session from the UE, which request is adapted to comprise a third indication indicating an AR service requested for the AR session,
send the request comprising the third indication towards a remote side of the AS session,
select a media function for the AR session based on the third indication and a response to the request from the remote side, and,
set up the AR session between the UE and a remote end, using the selected media function for the AR session.

According to an aspect of embodiments herein, the object is achieved by a User Equipment, UE, configured to handle an Augmented Reality, AR, Service in a communications network. The UE is further configured to:
Receive a second indication from a network node, which second indication is adapted to indicate that AR capability is supported in a conversation AR network,
based on the second indication, send to the network node, a request for an AR session, which request is adapted to comprise a third indication indicating an AR service requested for the AR session, which request comprising the third indication is adapted to be forwarded towards a remote side of the AS session,
obtain from the network node, a setup of the AR session using a media function for the AR session, which media function is selected based on the third indication.

Thanks to that the first indication indicating that the UE is AR capable, followed by the second indication indicating that AR capability is supported in a conversation AR network and the third indication indicating an AR service requested for the AR session indications are sent in the network, the handling of an AR service for the UE in the communications network is improved.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating embodiments of a communications network.

FIG. 3 is a flowchart depicting an embodiment of a method in a network node.

FIG. 4 is a flowchart depicting an embodiment of a method in a user equipment.

FIG. 5 is a schematic block diagram illustrating embodiments herein.

FIG. 6 is a sequence diagram illustrating an example embodiment of a method herein.

FIG. 7 is a schematic block diagram illustrating embodiments of a network node.

FIG. 8 is a schematic block diagram illustrating embodiments of a user equipment.

FIG. 9 schematically illustrates embodiments of a communication system.

FIG. 10 is a generalized block diagram of embodiments of a UE.

FIG. 11 is a generalized block diagram of embodiments of a network node.

FIG. 12 is a generalized block diagram of embodiments of a host.

FIG. 13 is a generalized block diagram of embodiments of a virtualization environment.

FIG. 14 is a generalized block diagram of embodiments of a communication diagram of a host.

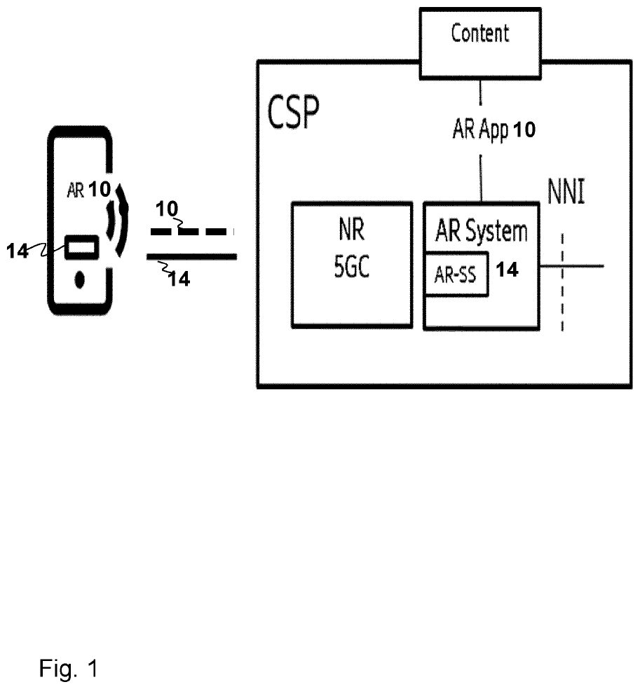

### DETAILED DESCRIPTION

Examples of embodiments provide an AR/UE Capability Negotiation. They relate to technical areas e.g., comprising IMS based telephony evolution, Conversational AR, and AR Telephony, such as AR using IMS architecture.

Example embodiments herein provide an AR-UE capability negotiations framework that will enable a serving network and/or service engine to determine that a request is for an AR service on an AR enabled device. It may also aid the AR enabled device to determine what AR capability the network supports.

An example of a method according to embodiments herein e.g., comprises the following tags also referred to as indications:

Service tagging: A UE first performs indication setting & propagation of the AR capability tag by the UE during IMS registration (Model 1). E.g., a first indication indicating that the UE is AR capable, also referred to as 3gpp.ARcapability=“enabled”.

The network node such as e.g., IMS functions like Proxy-Call Session Control Function (P-CSCF), Serving-Call Session Control Function (P-CSCF), multimedia telephony service Application server (MMTel-AS), Standard Contractual Clauses Application Server (SCC AS) etc. may receive and store the indication such as e.g., the tag. A SIP response returned by the network node to the UE comprises a second indication indicating whether or not AR capability is supported in the IMS network.

Service tagging: The UE sets and propagates a third indication indicating an AR service requested for an AR session, e.g. in an AR capability tag. The AR service may e.g. be related to network media rendering, a conference, a multi-party session, or a multi-party session conference.

This may e.g. be performed by the UE at IMS Invite (Model 1). The IMS network node, such as e.g., IMS functions like P-CSCF, S-CSCF, MMTel AS. SCC AS etc. may receive and store the indication, such as e.g. the tag, and use it to provide requested AR service. IMS network node s such as IMS functions at the terminating end may receive and store the indication such as e.g., the tag and use it to provide requested service, this may e.g. relate to influence call routing, e.g., multi-device handling. A SIP response, e.g., 183 or 200OK, returned to the UE may indicate whether or not requested service is supported. The indication such as the tag may also be used in accounting output.

Subscription tagging: The first indication that the UE is AR enabled, may e.g., be configured as part of the subscriber's profile, tied to the user's private identity related to the UE e.g., in Home Subscriber Server (HSS). At IMS registration Model 1, the first indication indicating that the UE is AR capable, such as e.g. the tag, may be downloaded and used by the network such as the network node.

The IMS network node such as the S-CSCF downloads the user profile with provisioned first indication, such as the AR tag. This first indication may then be subsequently distributed to IMS network functions that may need to avail of it. The first indication such as the tag is stored for later use by the IMS network node such as the network functions, indicating subscription support for AR service. The second indication is returned to the UE, e.g. in 200 Ok Register, indicating whether AR service is supported in the IMS network.

The service and subscription tagging are not mutually exclusive (they can be combined to complement each other) however based on implementation configuration options chosen they can also be deployed/implemented on their own.

Embodiments herein may provide one or more of the following advantages:

Embodiments herein enable the serving network such as an network node, to determine AR capabilities of the UE and thus act accordingly, e.g., invoke specific functions etc. Embodiments herein also enable the UE to request specific AR services, and combinations of same, again allowing the serving network, such as the network node in the serving network, to respond in an optimized fashion.

Embodiments herein enable the UE to determine if the IMS network it is requesting AR services from can support said request.

Embodiments herein enable also enables the network to determine if the user has subscribed to AR enabled services.

The framework provided by embodiments herein enable may be configurable, i.e., which mechanism shall be used, one or both. The framework may also be extensible.

The first, second and third indications, e.g., in the form of service tagging mechanism may be extendable, whereby the construction of the provided first, second and third indications, such as the capability feature tag, is by design multi-value.

The framework may also alleviate the need for extensive configuration in the network.

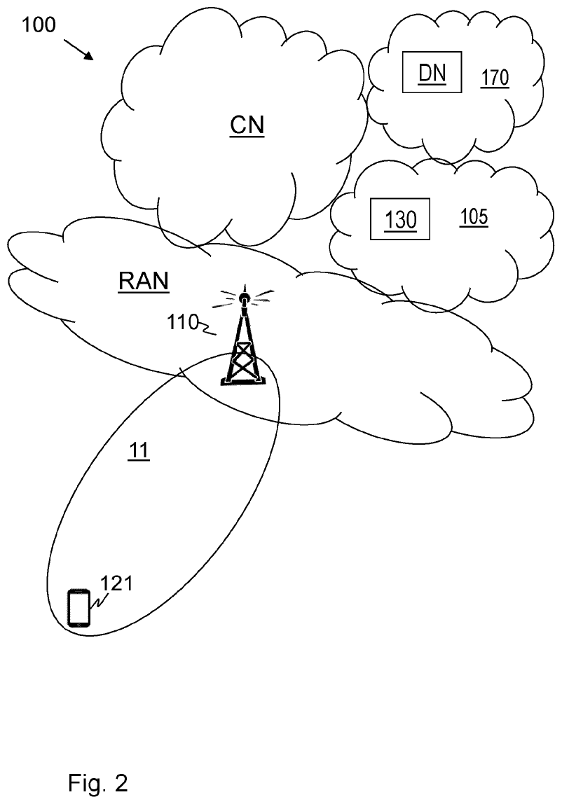

FIG. 2 is a schematic overview depicting a communications network 100 wherein embodiments herein may be implemented. The communications network 100 comprises one or more RANs, one or more CNs and a conversation AR network 105. The communications network 100 may use 5G NR but may further use a number of other different technologies, such as, 6G, Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

Base stations such as the base station 110 operate in the RAN the communications network 100. The base station 101 provides one or more cells such as a first cell 11. The base station 110 may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point or an Access Point Station (AP STA), an access controller, or any other network unit capable of communicating with UEs, such as a UE 121, within the first cell 11, served by the base station 110. The base station 110 may be referred to as a serving radio network node and communicates with the UE 121 with Downlink (DL) transmissions to the UE 121 and Uplink (UL) transmissions from the UE 121.

Network nodes, such as a network node 130, operate in the communications network 100.

In some embodiments, also referred to as Model 1, the conversation AR network 105 is represented by an IMS network. In these embodiments the network node 130 is represented by an IMS network node. According to embodiments herein the IMS network node may be or may comprise any one or more out of: a P-CSCF node, a S-CSCF node, an IMS AS node, a P-CSCF network function, a S-CSCF network function, and an IMS AS network function.

In some other embodiments, also referred to as Model 2, the conversation AR network 105 is represented by a WebRTC network. In these other embodiments, the network node 130 is represented by a WebRTC network node.

One or more UEs operate in the communication network 100, such as e.g. the UE 121. The UE 121 is an AR capable device. The UE 121 may e.g. be 5G-RG, an AR device, a remote UE, a wireless device, an NR device, a mobile station, a wireless terminal, an NB-IoT device, an MTC device, an eMTC device, a CAT-M device, a WiFi device, an LTE device and an a non-access point (non-AP) STA, a STA, that communicates via a base station such as e.g. a base station 110, one or more Access Networks (AN), e.g. a RAN, to one or more core network (CN) nodes, in one or more CNs, one or more IMS network nodes, such as e.g. the network node 130 in the conversation AR network 105. The UE 121 may communicate with one or more CN nodes, and/or IMS network nodes, such as the network node 130. It should be understood by the skilled in the art that “UE” is a non-limiting term which means any terminal, client, mobile client, IMS client, wireless communication terminal, user equipment, Device to Device (D2D) terminal, or node e.g. smart phone, laptop, mobile phone, sensor, relay, mobile tablets or even a car or any small base station communicating within a cell.

Subscriber data nodes (not shown) may operate in the communications network 100. The subscriber data nodes may e.g. operate in the conversation AR network 105, the CN, or be connected to said IMS network 105 or CN. The subscriber data nodes stores and manages subscriber data and policies related to the subscriber's profile and credentials on the UEs, such as e.g. the UE 121, e.g. a Subscriber Identity Module (SIM). According to embodiments herein a subscriber data nodes may be a Home Subscriber Server (HSS) or a Policy Control Function (PCF) node.

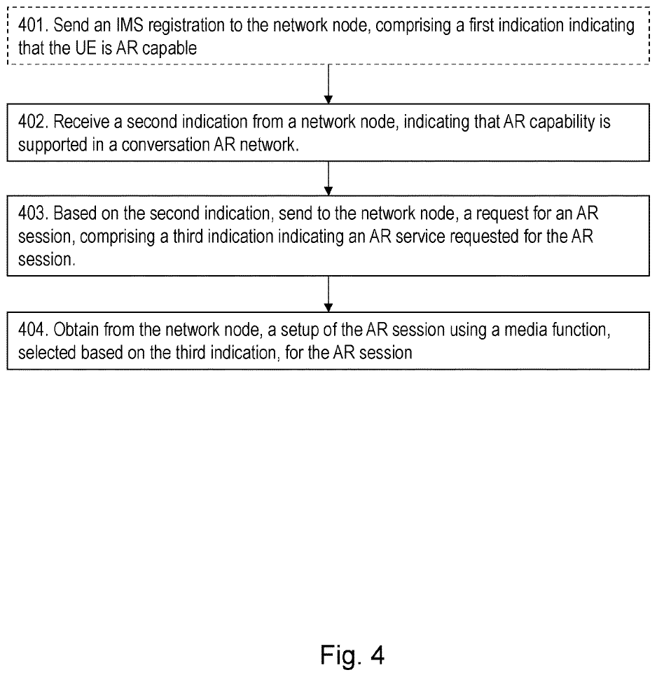

Methods according to embodiments herein are performed by the network node 130. This node may be Distributed Nodes (DN)s and functionality, e.g. comprised in a cloud 170 as shown in FIG. 4.

A number of embodiments will now be described, some of which may be seen as alternatives, while some may be used in combination.

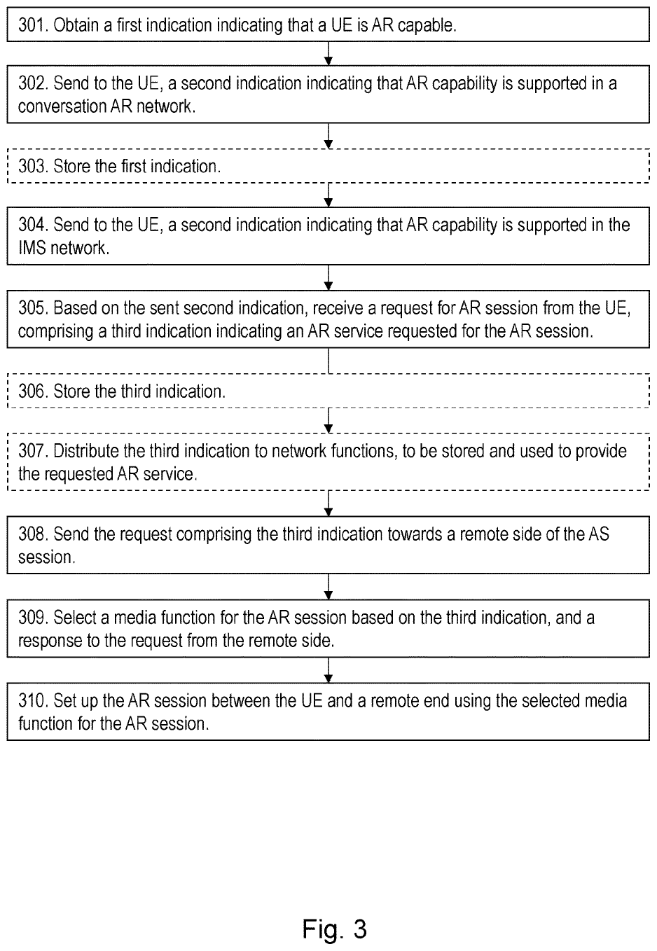

A method according to embodiments will first be described as seen from the view of the network node 130 together with FIG. 3, and then as seen from the view of the UE 121 together with FIG. 4.

FIG. 3 shows exemplary embodiments of a method performed by the network node 130, such as e.g., an I-CSCF node, an S CSCF node, a P-CSCF node, and/or an IMS AS. The method is for handling an AR Service for the UE 121 in the communications network 100. In some embodiments, also referred to as Model 1, the conversation AR network 105 is represented by an IMS network. In these embodiments the network node 130 is represented by an IMS network node. In some other embodiments, also referred to as Model 2, the conversation AR network 105 is represented by a WebRTC network. In these other embodiments, the network node 130 is represented by a WebRTC network node.

The method comprises the following actions, which actions may be taken in any suitable order. Optional actions are referred to as dashed boxes in FIG. 3.

According to an example scenario, the UE 121 is about to request an AR service to be served in the conversation AR network 105, e.g., for AR telephony for sending and/or receiving media, such as e.g., any one or more out of audio, video and AR media.

### Action 301

The network node 130 obtains a first indication indicating that the UE 121 is AR capable. This may be done to let the network node 130 know that the UE 121 is AR capable. The first indication indicates whether or not the UE 121 is AR capable, which it is according to this example scenario.

In some embodiments relating to model 1, the first indication indicating that the UE 121 is AR capable may be obtained by receiving an IMS registration from the UE 121, which IMS registration comprises the first indication indicating that the UE 121 is AR capable.

In some other embodiments relating to any of model 1 or model 2, the first indication indicating that the UE 121 is AR capable may be obtained by downloading the first indication from a user subscriber's profile related to the UE 121.

### Action 302

In some embodiments, the network node 130 configures the first indication, e.g., in a tag, as part of a user subscriber's profile related to the UE 121, e.g., tied to the user's private identity in HSS.

The wordings “tag”, “indicator” and “indication”, as used herein, shall be seen as having the same or similar meaning, and can be used interchangeably herein.

### Action 303

In some embodiments, the network node 130 stores the first indication. The stored first indication may be used at a later occasion. E.g., to indicate that the UE 121 supports for example conversation AR and thus specific service policies, e.g., do not invoke service fallback to CS etc., may be invoked for requested service.

### Action 304

The network node 130 sends a second indication to the UE 121. The second indication is indicating that AR capability is supported in the conversation AR network 105. This may be done to let the UE 121 know that a conversation AR network 105 in the communications network 100 supports AR services. In this way the UE 121 knows that it is possible to request an AR session for an AR service to be set up between the UE 121 and a remote end.

The second indication indicates whether or not the AR capability is supported in the conversation AR network 105, which it is according to this example scenario.

### Action 305

Based on the sent second indication, the network node 130 receives a request for an AR session from the UE 121, e.g., in an invite message. The request comprises a third indication indicating an AR service requested for the AR session, E.g., when the UE 121 knows that AR services are supported as indicated in the second indication, it requests an AR session for an AR service requested for the AR session.

The third indication may comprise an extendable value indicating what type of AR service the AR session relates to. The extendable value indicating what type of AR service the AR session relates may be representing any one or more out of: Network media rendering, a conference, a multi-party session, and a multi-party session conference.

### Action 306

The network node 130 may store the third indication. The stored third indication may be used at a later occasion. E.g., to implement policies related to the specific service request, such as e.g. suppress invocation of particular MMTel service not relevant to the service request.

### Action 307

In some embodiments, the network node 130 distributes the third indication, e.g., in a tag, to network functions such as e.g., P-CSCF, S-CSCF, MMTel AS, SCC AS, to be stored and used to provide the requested AR service.

### Action 308

The network node 130 sends the request comprising the third indication towards a remote side of the AS session. This is performed to indicate to the remote side the characteristics of the service request, e.g., AR media rendering functionality is requested to be supported,

### Action 309

The network node 130 selects a media function for the AR session, such as e.g., functionality for an AGW close to the UPG. The selecting is based on the third indication, and a response to the request from the remote side.

This is performed to enhance the Quality of Experience (QoE) of the service being requested.

### Action 310

The network node 130 sets up the AR session between the UE 121 and a remote end using, the selected IMS media function for the AR session.

The selected IMS media function is used to provide AR media capabilities to the requested session.

In this way by using the method, QoE is guaranteed to the requesting services without the need for extensive network configuration, such as e.g., a selection initiation mechanism of appropriate gateways based on capability tag.

FIG. 4 shows exemplary embodiments of a method performed by the UE 121. The method is for handling an AR Service in the communications network 100. In some embodiments, also referred to as Model 1, the conversation AR network 105 is represented by an IMS network. In these embodiments the network node 130 is represented by an IMS network node. In some other embodiments, also referred to as Model 2, the conversation AR network 105 is represented by a WebRTC network. In these other embodiments, the network node 130 is represented by a WebRTC network node.

The method comprises the following actions, which actions may be taken in any suitable order. Optional actions are referred to as dashed boxes in FIG. 4.

### Action 401

In some embodiments relating to Model 1, the UE 121 sends an IMS registration to the network node 130 operating in the IMS network 105. The IMS registration comprises a first indication indicating that the UE 121 is AR capable.

### Action 402

The UE 121 receives a second indication from the network node 130. The second indication is indicating that AR capability is supported in the conversation AR network 105. This lets the UE 121 know that a conversation AR network 105 in the communications network 100 supports AR services. In this way the UE 121 knows that it is possible to request an AR session for an AR service to be set up between the UE 121 and a remote end.

### Action 403

Based on the second indication, the UE 121 sends a request for an AR session to the network node 130. E.g., based on that UE 121 knows that a conversation AR network 105 in the communications network 100 supports AR services. The request may, e.g., be sent in an invite message. The request comprises a third indication. The third indication indicates an AR service requested for the AR session. The request comprising the third indication is to be forwarded towards a remote side of the AS session.

The third indication may comprise an extendable value indicating what type of AR service the AR session relates to. The extendable value indicating what type of AR service the AR session relates to may be representing any one or more out of: Network media rendering, a conference, a multi-party session, and a multi-party session conference.

### Action 404

The UE 121 obtains from the network node 130, a setup of the AR session using an IMS media function for the AR session, e.g., an IMS media function optimized for the AR session. The IMS media function is selected based on the third indication. This may mean that the network node 130 sets up the AR session.

In this way by using the method, the requesting service is guaranteed quality of experience.

Embodiments herein such as the embodiments mentioned above will now be further described and exemplified. The text below is applicable to and may be combined with any suitable embodiment described above.

In some embodiments herein, the AR-UE capability negotiation framework builds partly on media feature tag concept as outlined in 3GPP TS 24.229, IP multimedia call control protocol based on Session Initiation Protocol (SIP) and Session Description Protocol (SDP), Release 17. It comprises a number of mechanisms that may be used by the network, e.g., an IMS network node, to identify an AR enabled device type and by the AR enabled device to determine what the network supports.

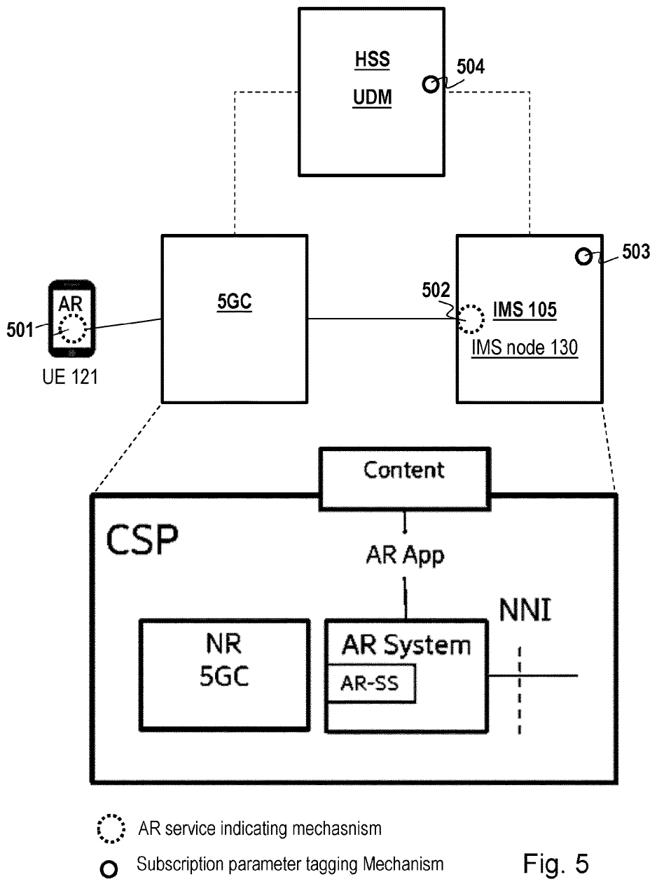

One such mechanism may avail of a device tagging paradigm, see FIG. 5 depicting an AR/UE Capability Negotiation framework. Here the AR enabled device, such as the UE 121 may use its AR service indicating mechanism 501 to indicate in service requests the third indication i.e., indicating the AR service requested for the AR session. This may be performed by tagging its service requests with the third indication, e.g. by using SIP in Model 1, or as WebRTC based in Model 3.

The service requests are sent to an AR service indicating mechanism 502 in the network node 130, such as an IMS network node, with the third indicator that shall be used by network functions, e.g., the IMS network node, to identify that the request is from an AR enabled device, and act accordingly.

Example of names, descriptions, and values of different first second and third indications, e.g., comprising the provided capability feature tag also referred to as 3gpp.ARcapability, are shown in Table 1 below. The AR enabled UE 121 adds the indications according to its capabilities, it is proposed that this these indications, such as e.g. tags, are extended values, e.g. for extensibility purposes etc.

TABLE 1
AR-UE Capability feature tag example construct & values.

| Feature tag name | Value | Description |
|---|---|---|
| 3gpp.Arcapability | — | Intended primarily for use in |
| | | applications, protocols, services, or |
| | | negotiation mechanisms: useful in |
| | | an AR communications system / |
| | | network, for describing the AR |
| | | capabilities of the device & AR |
| | | service requested by said device. |
| 3gpp.ARcapability | “enabled” | Indication of support of AR in UE |
| | | (e.g. STAR / EDGAR support etc.). |
| 3gpp.ARcapability | “network_media_rendering” | Service requires network media |
| | | rendering via a rendering server to |
| | | offload the AR capable (EDGAR) |
| | | device. |
| 3gpp.ARcapability | “conference” | Service AR has conference support |
| 3gpp.ARcapability | “multi_party_AR_session” | Service AR multi party support |
| 3gpp.ARcapability | multi_party_AR_session, | Service AR supports both multi |
| | conference | party & conference |

Referring again to FIG. 5. Another mechanism according to embodiments herein, that this AR-UE capability negotiation framework may avail of is an AR subscription tagging mechanism 503 by e.g. the IMS network or network node 130. A user subscriber's subscription related to the UE 121, e.g., the user's IP Multimedia Private Identity (IMPI), International Mobile Subscriber Identity (IMSI) and/or Subscription Permanent Identifier (SUPI) may be tied to a parameter, tag, indication and/or indicator by using the AR subscription tagging mechanism 504 in the UDM and/or HSS. It may be retrieved at the user's registration and distributed to the relevant functions. The receiving network functions may now determine that the user's subscription also supports the AR service.

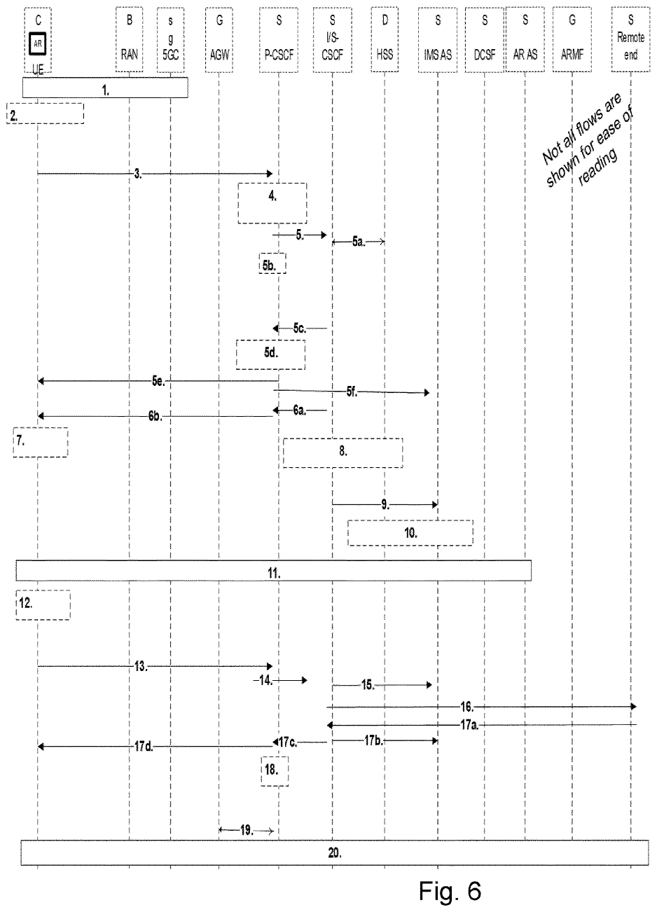

Some steps 1-20 of the method according to an example scenario of embodiments herein, relating to Model 1, is shown in the sequence diagram depicted in FIG. 6.

1) The UE 121 initiates a 5GC registration.

2) The UE 121 initiates an IMS registration. It avails AR capability negotiation framework and includes the first indication, such as for example the capability tag “3gpp.ARcapability=enabled” indicating support of AR capability, e.g., a STandalone AR UE (STAR) and/or Edge Dependent AR UE (EDGAR) enabled, in the UE 121.

3) The register comprising a capability tag is received by the network node 130 such as e.g. the P-CSCF node.

4) The P-CSCF of the network node 130 will store the first indication such as e.g. the capability tag for later use.

5) The Register is forwarded to CSCF of the network node 130.

5) 5A: The network node 130 downloads the subscriber profile related to the UE 121 from the HSS.

5) 5B: The network node 130 adds the first indication such as the AR-enabled tag to the profile. The network node 130, such as e.g. the S-CSCF may check if “AR subscription tagging mechanism” is configured for use in the network. It should be noted that this may be an implementation deployment option. If yes and an “AR service tag” has not been received or is not configured (again can be an implementation deployment option that is configured) then the network node 130 such as e.g. the S-CSCF includes the received tag in the updated Register response and proceeds with step 5C. Else the network node 130 such as e.g. the S-CSCF initiates step 6.

5) 5C: A 200OK message with the first indication, e.g. the tag is received by the P-CSCF of the network node 130.

5) 5D: The P-CSCF of the network node 130 stores the received first indication such as e.g., the AR enabled tag for later use.

5) 5E: A response is returned to the UE 121. The UE 121 is now aware that the network supports AR capability.

5) 5F A Register, e.g., 3rd party, is sent to the IMS AS from S-CSCF of the network node 130. The IMS AS stores the tag for future use.

6) 6A. Continued from 5B—the AR service tag mechanism is supported. A SIP 200 OK message is returned to the UE 121 indicating a successful registration with capability set to supported comprising the second indication indicating that the network supports the requested capability.

7) The UE 121 is now aware that the network supports the requested capability, in this case AR.

8) The S-CSCF of the network node 130 stores the first indication, such as e.g. the capability tag which may be availed of later. It may be used for suppression of certain AS's, e.g., SCC AS, if deemed necessary.

9) The 3rd party registration is sent to the IMS AS of the network node 130, with t the first indication such as e.g. the newly included capability tag.

10) The IMS AS of the network node 130 stores the capability tag which may be availed of later. It may be used for suppression of certain services if deemed necessary.

11) The UE 121 downloads a specific AR application (by for example using DC bootstrapping functionality.

12) The UE 121 initiates an AR session with conversation. The UE 121 avails of the newly introduced AR capability negotiation framework to include and/or append the third indication such as e.g. an AR service specific capability tag for example “3gpp.ARcapability=network_media_rendering” indicating that its specific AR service requires network media rendering via a rendering server to offload the UE 121, being an AR capable, e.g. EDGAR, device.

13) The Invite message with the third indication such as e.g. the capability tag is received by the P-CSCF of the network node 130. The tag is stored in P-CSCF of the network node 130.

14-16) The Invite message comprising the third indication such as e.g. the capability tag, is sent further up in the network and towards the remote side.

17) a-d A SIP 183 message is returned from the remote side toward UE 121.

18) The P-CSCF of the network node 130, shall based on the remote side's response and earlier stored capability tag indicating network_media_rendering, initiate selection functionality for an AGW close to the UPG for this UE 121 and this particular session request, i.e. the use of the AR service capability feature tag to dynamically, e.g. per session, initiate selection functionality for an AGW close to the UPG.

19) The P-CSCF of the network node 130 will initiate an “add resources” request to the AGW that was deemed closest to the UPG serving the UE 121.

20) The call set up (SIP) procedures and procedures to add AR media continues. The AR-AS based on the third indication such as e.g. the newly introduced capability tag (e.g., “3gpp.ARcapability=network_media_rendering”) shall initiate selection functionality for an ARMF supporting network rendering.

To perform the method actions above, the network node 130 is configured to handle an AR service for the UE 121 in the communications network 100.

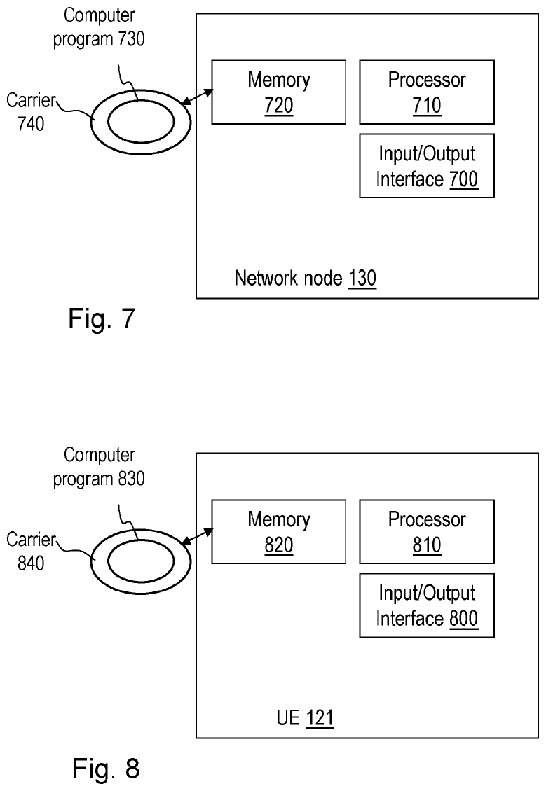

The network node 130 may comprise an arrangement depicted in FIG. 7. The network node 130 may comprise an input and output interface 700 configured to communicate in the communications network 100, e.g., with the UE 121. The input and output interface 700 may comprise a wireless receiver not shown, and a wireless transmitter not shown.

The network node 130 is further configured to obtain a first indication indicating that the UE 121 is AR capable and send to the UE 121, a second indication indicating that AR capability is supported in a conversation AR network 105. The network node 130 is further configured to, based on the sent second indication, receive a request for an AR session from the UE 121, which request is adapted to comprise a third indication indicating an AR service requested for the AR session. The network node 130 is further configured to send the request comprising the third indication towards a remote side of the AS session, and select a media function for the AR session based on the third indication and a response to the request from the remote side. The network node 130 is further configured to set up the AR session between the UE 121 and a remote end, using the selected IMS media function for the AR session.

In some embodiments, the network node 130 is further configured to any one or more out of: configure the first indication as part of a user subscriber's profile related to the UE 121, store the first indication, store the third indication, and distribute the third indication to IMS functions to be stored and used to provide the requested AR service.

The network node 130 may further be configured to obtain the first indication indicating that the UE 121 is AR capable by any one out of: Receive an IMS registration from the UE 121, which IMS registration comprises the first indication indicating that the UE 121 is AR capable and download the first indication from the subscriber's profile related to the UE 121.

In some embodiments, any one out of: The conversation AR network 105 is adapted to be represented by an Internet Protocol Multimedia Subsystem, IMS, network, and the network node 130 is adapted to be represented by an IMS network node, or the conversation AR network 105 is adapted to be represented by a Web Real-Time Communication, WebRTC, network and the network node 130 is adapted to be represented by a WebRTC network node.

The third indication may be adapted to comprise an extendable value indicating what type of AR service the AR session relates to. The extendable value indicating what type of AR service the AR session relates may be adapted to represent any one or more out of: Network media rendering, a conference, a multi-party session, and a multi-party session conference.

To perform the method actions above, the UE 121 is configured to handle an AR service in a communications network 100.

The UE 121 may comprise an arrangement depicted in FIG. 8. The UE 121 may comprise an input and output interface 800 configured to communicate in the communications network 100, e.g., with the network node 130, and the base station 110. The input and output interface 800 may comprise a wireless receiver not shown, and a wireless transmitter not shown.

The UE 121 is further configured to receive a second indication from a network node 130, which second indication is adapted to indicate that AR capability is supported in a conversation AR network 105. The UE 121 is further configured to, based on the second indication, send to the network node 130, a request for an AR session. The request is adapted to comprise a third indication indicating an AR service requested for the AR session. The request comprises the third indication is adapted to be forwarded towards a remote side of the AS session. The UE 121 is further configured to obtain from the network node 130, a setup of the AR session using a media function for the AR session, which media function is selected based on the third indication.

The UE 121 may further be configured to send an IMS registration to the network node 130, which IMS registration comprises a first indication indicating that the UE 121 is AR capable.

In some embodiments, any one out of: The conversation AR network 105 is adapted to be represented by an Internet Protocol Multimedia Subsystem, IMS, network, and the network node 130 is adapted to be represented by an IMS network node, or the conversation AR network 105 is adapted to be represented by a Web Real-Time Communication, WebRTC, network and the network node 130 is adapted to be represented by a WebRTC network node.

The third indication may be adapted to comprise an extendable value indicating what type of AR service the AR session relates to. The extendable value indicating what type of AR service the AR session relates may be adapted to represent any one or more out of: Network media rendering, a conference, a multi-party session, a multi-party session conference.

Embodiments herein may be implemented through a respective processor or one or more processors, such as the respective processor 710 of a processing circuitry in the network node 130 depicted in FIG. 7, and processor 810 of a processing circuitry in the UE 121 depicted in FIG. 8 together with respective computer program code for performing the functions and actions of the embodiments herein. The program code mentioned above may also be provided as a computer program product, for instance in the form of a data carrier carrying computer program code for performing the embodiments herein when being loaded into the respective network node 130 and UE 121. One such carrier may be in the form of a CD ROM disc. It is however feasible with other data carriers such as a memory stick. The computer program code may furthermore be provided as pure program code on a server and downloaded to the respective network node 130 and UE 121.

The network node 130 and UE 121 may further comprise a respective memory 720 and memory 820 comprising one or more memory units. The respective memory 720 and memory 820 comprises instructions executable by the processor in the respective network node 130 and UE 121. The respective memory 720 and memory 820 are arranged to be used to store e.g., media functions, indications, tags, information, data, configurations, communication data, and applications to perform the methods herein when being executed in the respective network node 130 and UE 121.

In some embodiments, a respective computer program 730 and computer program 830 comprises instructions, which when executed by the respective at least one processor 710 and processor 810, cause the at least one processor of respective network node 130 and UE 121 to perform the actions above.

In some embodiments, a respective carrier 740 and carrier 840 comprises the respective computer program 730 and computer program 830, wherein the respective carrier 740 and carrier 840 is one of an electronic signal, an optical signal, an electromagnetic signal, a magnetic signal, an electric signal, a radio signal, a microwave signal, or a computer-readable storage medium.

Those skilled in the art will appreciate that units in the respective network node 130 and UE 121 described above may refer to a combination of analog and digital circuits, and/or one or more processors configured with software and/or firmware, e.g. stored in the respective network node 130 and UE 121, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

### Additional Explanation

Some of the embodiments contemplated herein will now be described more fully with reference to the accompanying drawings. Embodiments are provided by way of example to convey the scope of the subject matter to those skilled in the art.

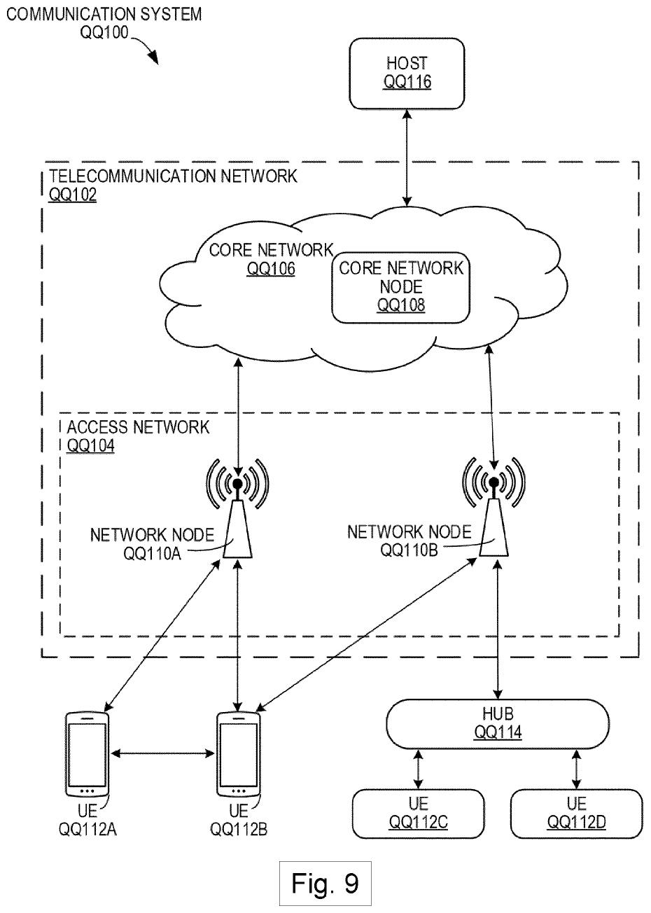

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs 121, QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

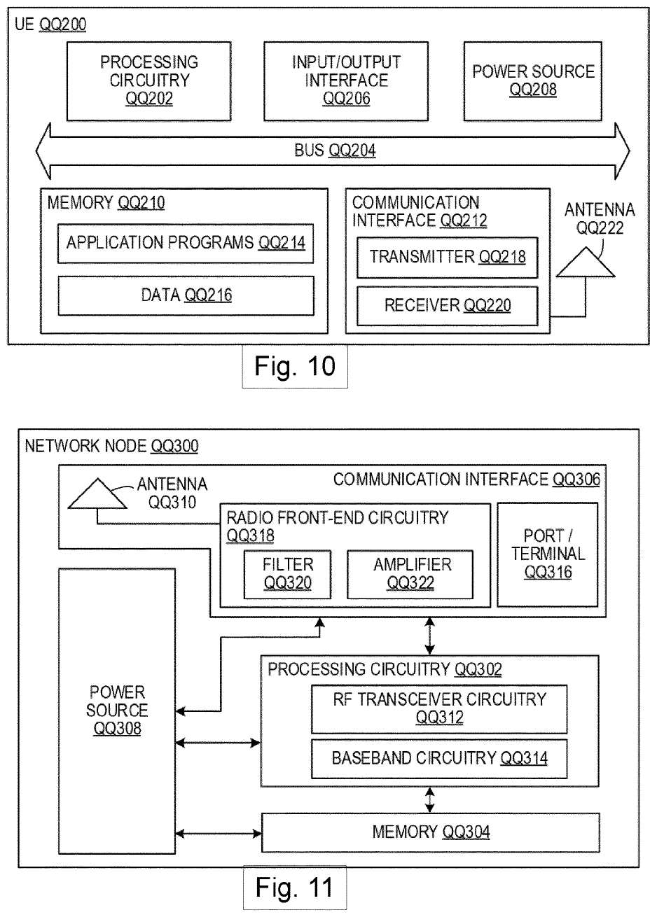

FIG. 10 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 11 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

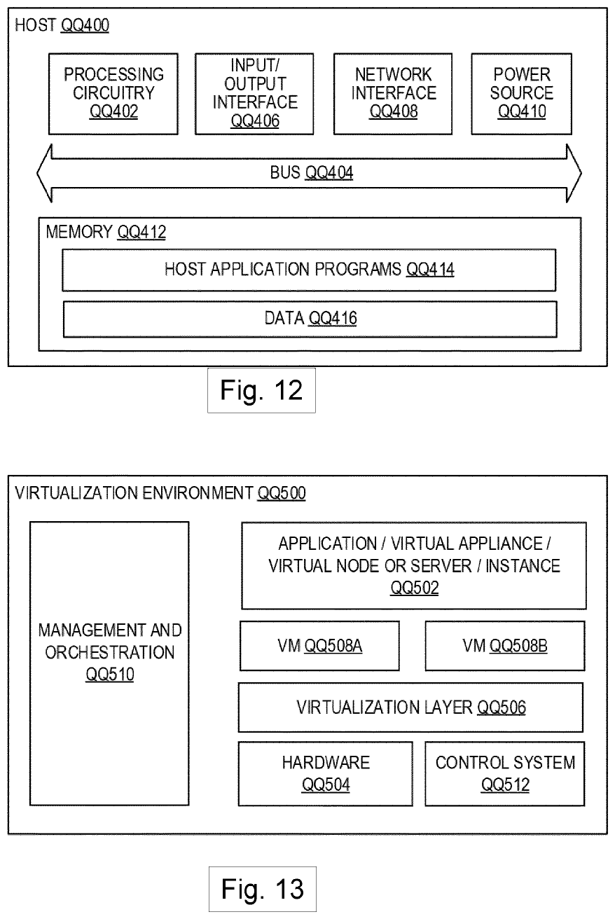

FIG. 12 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

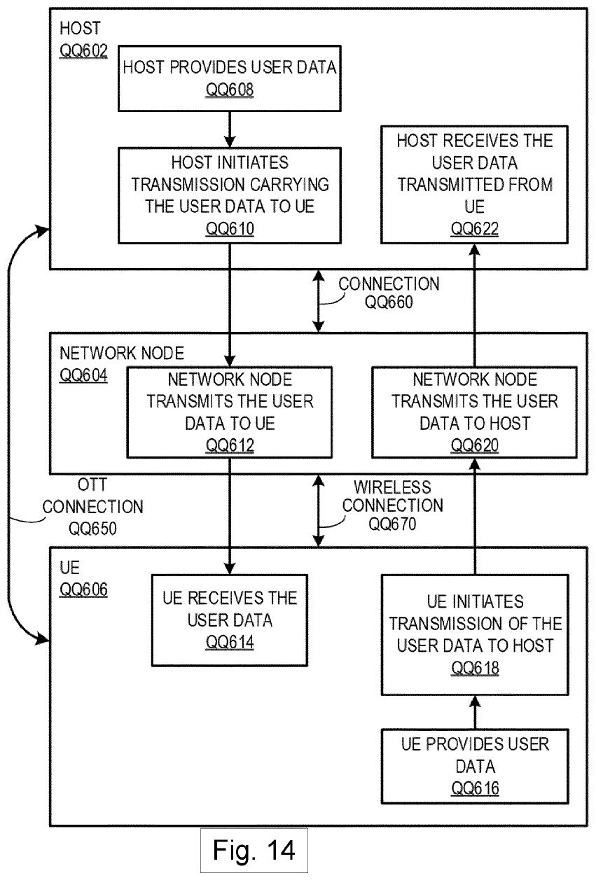

FIG. 14 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9 and/or UE QQ200 of FIG. 10), network node (such as network node QQ110a of FIG. 9 and/or network node QQ300 of FIG. 11), and host (such as host QQ116 of FIG. 9 and/or host QQ400 of FIG. 12) discussed in the preceding paragraphs will now be described with reference to FIG. 14.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the latency and thereby provide benefits such as reduced user waiting time.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1. A method performed by a network node, for handling an Augmented Reality (AR), Service for a User Equipment (UE) in a communications network, the method comprising:
obtaining a first indication indicating that the UE is AR capable,
sending, to the UE, a second indication indicating that AR capability is supported in a conversation AR network,
based on the sent second indication, receiving a request for an AR session from the UE, which request comprises a third indication indicating an AR service requested for the AR session,
sending the request comprising the third indication towards a remote side of the AR session,
selecting a media function for the AR session based on the third indication, and a response to the request from the remote side, and,
setting up the AR session between the UE and a remote end using the selected media function for the AR session.

2. The method according to claim 1, further comprising any one or more out of:
configuring the first indication as part of a user subscriber's profile related to the UE,
storing the first indication,
storing the third indication, and
distributing the third indication, to network functions to be stored and used to provide the requested AR service.

3. The method according to claim 1, and wherein obtaining the first indication indicating that the UE is AR capable comprises any one out of:
receiving an Internet Protocol Multimedia Subsystem (IMS) registration from the UE, which IMS registration comprises the first indication indicating that the UE is AR capable, or
downloading the first indication from a user subscriber's profile related to the UE.

4. The method according to claim 1, wherein any one out of:
the conversation AR network is represented by an Internet Protocol Multimedia Subsystem (IMS) network, and the network node is represented by an IMS network node, or
the conversation AR network is represented by a Web Real-Time Communication (WebRTC) network and the network node is represented by a WebRTC network node.

5. The method according to claim 1, wherein the third indication comprises an extendable value indicating what type of AR service the AR session relates to.

6. The method according to claim 5, wherein the extendable value indicating what type of AR service the AR session relates is representing any one or more out of:
network media rendering,
a conference,
a multi-party session, and
a multi-party session conference.

7-8. (canceled)

9. A method performed by a User Equipment (UE) for handling an Augmented Reality (AR) Service in a communications network, the method comprising:
receiving a second indication from a network node, which second indication indicates that AR capability is supported in a conversation AR network,
based on the second indication, sending, to the network node, a request for an AR session, which request comprises a third indication indicating an AR service requested for the AR session, which request comprising the third indication is to be forwarded towards a remote side of the AS session, and
obtaining from the network node, a setup of the AR session using a media function for the AR session, which media function is selected based on the third indication.

10. The method according to claim 9, further comprising:
sending an Internet Protocol Multimedia Subsystem (IMS) registration to the network node, which IMS registration comprises a first indication indicating that the UE is AR capable.

11. The method according to claim 9, wherein any one out of:
the conversation AR network is represented by an Internet Protocol Multimedia Subsystem (IMS) network, and the network node is represented by an IMS network node, or
the conversation AR network is represented by a Web Real-Time Communication (WebRTC) network and the network node is represented by a WebRTC network node.

12. The method according to claim 9, wherein the third indication comprises an extendable value indicating what type of AR service the AR session relates to.

13. The method according to claim 10, wherein the extendable value indicating what type of AR service the AR session relates is representing any one or more out of:
network media rendering,
a conference,
a multi-party session, and
a multi-party session conference.

14-15. (canceled)

16. A network node configured to handle an Augmented Reality (AR) Service for a User Equipment (UE) in a communications network, the network node further being configured to:
obtain a first indication indicating that the UE is AR capable,
send, to the UE, a second indication indicating that AR capability is supported in a conversation AR network,
based on the sent second indication, receive a request for an AR session from the UE, which request is adapted to comprise a third indication indicating an AR service requested for the AR session,
send the request comprising the third indication towards a remote side of the AS session,
select a media function for the AR session based on the third indication and a response to the request from the remote side, and
set up the AR session between the UE and a remote end, using the selected IMS media function for the AR session.

17. The network node according to claim 16, further being configured to any one or more out of:
configure the first indication as part of a user subscriber's profile related to the UE,
store the first indication,
store the third indication, and
distribute the third indication to Internet Protocol Multimedia Subsystem (IMS) functions to be stored and used to provide the requested AR service.

18. The network node according to claim 16, further being configured to obtain the first indication indicating that the UE is AR capable by any one out of:
receive an Internet Protocol Multimedia Subsystem (IMS) registration from the UE, which IMS registration comprises the first indication indicating that the UE is AR capable, and
download the first indication from the subscriber's profile related to the UE.

19. The network node according to claim 16, wherein any one out of:
the conversation AR network is adapted to be represented by an Internet Protocol Multimedia Subsystem (IMS) network, and the network node is adapted to be represented by an IMS network node, or
the conversation AR network is adapted to be represented by a Web Real-Time Communication (WebRTC) network and the network node is adapted to be represented by a WebRTC network node.

20. The network node according to claim 16, wherein the third indication is adapted to comprise an extendable value indicating what type of AR service the AR session relates to.

21. The network node according to claim 20, wherein the extendable value indicating what type of AR service the AR session relates is adapted to represent any one or more out of:
network media rendering,
a conference,
a multi-party session, and
a multi-party session conference.

22. A User Equipment (UE) configured to handle an Augmented Reality (AR) Service communications network, the UE further being configured to:
receive a second indication from a network node, which second indication is adapted to indicate that AR capability is supported in a conversation AR network,
based on the second indication, send to the network node a request for an AR session, which request is adapted to comprise a third indication indicating an AR service requested for the AR session, which request comprising the third indication is adapted to be forwarded towards a remote side of the AS session, and
obtain from the network node, a setup of the AR session using a media function for the AR session, which media function is selected based on the third indication.

23. The UE according to claim 22, further being configured to:
send an Internet Protocol Multimedia Subsystem (IMS) registration to the network node, which IMS registration comprises a first indication indicating that the UE is AR capable.

24. The UE according to claim 22, wherein any one out of:
the conversation AR network is adapted to be represented by an Internet Protocol Multimedia Subsystem (IMS) network, and the network node is adapted to be represented by an IMS network node, or
the conversation AR network is adapted to be represented by a Web Real-Time Communication (WebRTC) network and the network node is adapted to be represented by a WebRTC network node.

25-26. (canceled)
